(19) United States
(12) Patent Application Publication
(10) Pub. No.: US 2026/0128500 A1
(43) Pub. Date: May 7, 2026

(54) WIRELESS ADAPTERS

(71) Applicant: SHENZHEN SHOKZ CO., LTD., Shenzhen (CN)

(72) Inventors: Jianhua XIE, Shenzhen (CN); Yafei WANG, Shenzhen (CN); Fen YOU, Shenzhen (CN)

(73) Assignee: SHENZHEN SHOKZ CO., LTD., Shenzhen (CN)

(21) Appl. No.: 19/435,728

(22) Filed: Dec. 29, 2025

Related U.S. Application Data
(63) Continuation of application No. PCT/CN2024/096407, filed on May 30, 2024.

(51) Int. Cl. H01Q 1/22; H01Q 21/28

(52) U.S. Cl. CPC H01Q 1/22; H01Q 21/28

(57) ABSTRACT

A wireless adapter comprises a housing assembly, an interface assembly, and an antenna assembly. The housing assembly includes an accommodation cavity formed inside the housing assembly. The interface assembly is disposed at one end of the housing assembly along a length direction of the wireless adapter. The antenna assembly is disposed in the accommodation cavity, and the antenna assembly is electrically connected to the interface assembly. The antenna assembly includes a first antenna and a second antenna, and a plane in which the first antenna is located intersecting with a plane in which the second antenna is located.

### CROSS-REFERENCE TO RELATED APPLICATIONS

This application is a continuation of International Application No. PCT/CN 2024/096407, filed on May 30, 2024, the contents of which are incorporated herein by reference to their entirety.

### TECHNICAL FIELD

The present disclosure relates to a field of wireless communication technologies, and more particularly, to a wireless adapter.

### BACKGROUND

Wearable devices, such as earphones and smart glasses, have become indispensable tools in people's daily lives and work. For some wearable devices without a wireless communication function, a wireless adapter (e.g., a Bluetooth adapter) is usually inserted into the wearable device to enable data and information interaction between the wearable device and an external device (e.g., a computer, a mobile phone, or the like) through the wireless adapter. However, existing wireless adapters have problems such as a narrow frequency bandwidth and poor directivity, which cannot meet application requirements of increasingly miniaturized wearable devices.

### SUMMARY

The primary technical problem to be solved by the present disclosure is to provide a wireless adapter having characteristics such as a wider frequency bandwidth and a more comprehensive signal coverage range.

In some embodiments, a wireless adapter is provided, comprising a housing assembly, an interface assembly, and an antenna assembly.

The housing assembly includes an accommodation cavity, and the accommodation cavity is formed inside the housing assembly.

The interface assembly is disposed at one end of the housing assembly along a length direction of the wireless adapter.

The antenna assembly is disposed in the accommodation cavity, and the antenna assembly is electrically connected to the interface assembly. The antenna assembly includes a first antenna and a second antenna, and a plane in which the first antenna is located intersecting with a plane in which the second antenna is located.

In some embodiments, the plane in which the first antenna is located is perpendicular to the plane in which the second antenna is located.

In some embodiments, the antenna assembly further comprises a wireless module. The wireless module is electrically connected to the first antenna, the second antenna, and the interface assembly, and the wireless module, the first antenna, and the second antenna cooperate with each other to enable the wireless adapter to transmit and receive signals within a certain frequency band.

In some embodiments, the wireless adapter further comprises a carrier board assembly disposed in the accommodation cavity. The carrier board assembly includes a first carrier board and a second carrier board. The first carrier board and the second carrier board are fixedly connected to the housing assembly. The first antenna is formed on a surface of the first carrier board, and the second antenna is formed on a surface of the second carrier board.

In some embodiments, a material hardness of the first carrier board is greater than a material hardness of the second carrier board, and the second carrier board is abutted and fixed to an inner wall of the housing assembly.

In some embodiments, the first carrier board is a rigid printed circuit board, and the second carrier board is a flexible printed circuit board.

In some embodiments, the housing assembly comprises an insulating shell and an insulating end cap.

The insulating shell includes a first end and a second end opposite to each other along the length direction. The interface assembly is disposed at the first end of the insulating shell, and the first carrier board is fixed inside the insulating shell.

The insulating end cap is disposed at the second end of the insulating shell. The accommodation cavity is formed between the insulating shell and the insulating end cap, and the second carrier board is stacked and fixed on an inner wall of the insulating end cap.

In some embodiments, a first positioning structure is formed between the insulating end cap and the second carrier board, and the first positioning structure is configured to position a relative position between the second carrier board and the insulating end cap.

In some embodiments, the first positioning structure includes a positioning protrusion and a positioning through hole. The positioning protrusion is disposed to protrude from the inner wall of the insulating end cap along the length direction. The positioning through hole is disposed to penetrate the second carrier board along the length direction, and the positioning protrusion is inserted through the positioning through hole to position the second carrier board and the insulating end cap.

In some embodiments, the wireless adapter further comprises a carrier board assembly disposed in the accommodation cavity. The carrier board assembly includes a first carrier board. The first carrier board is fixedly connected to the housing assembly. The first antenna is formed on a surface of the first carrier board, and the second antenna is formed on an inner wall of the housing assembly.

In one embodiment, the housing assembly comprises an insulating shell and an insulating end cap.

The insulating shell includes a first end and a second end opposite to each other along the length direction. The interface assembly is disposed at the first end of the insulating shell, and the first carrier board is fixed inside the insulating shell.

The insulating end cap disposed at the second end of the insulating shell. The accommodation cavity is formed between the insulating shell and the insulating end cap, and the second antenna is formed on an inner wall of the insulating end cap.

In some embodiments, the antenna assembly further comprises a feed point structure. The feed point structure is in electrical contact connection with the first antenna and the second antenna.

In some embodiments, the feed point structure comprises an elastic member. The elastic member includes a fixed end fixed relative to the first carrier board along the length direction and a free end movable relative to the first carrier board along the length direction. The fixed end of the elastic member is fixedly connected to the first carrier board and in electrical contact connection with the first antenna, and the free end of the elastic member is in elastic and electrical contact with the second antenna.

In some embodiments, a fixing structure is disposed between the insulating shell and the insulating end cap, and the fixing structure is arranged around the second antenna and configured to fix the insulating end cap to the insulating shell.

In some embodiments, the fixing structure includes a fixing protrusion and a fixing slot hole. The fixing protrusion is disposed to protrude from the inner wall of the insulating end cap along the length direction. The fixing slot hole is disposed inside the insulating shell, and the fixing protrusion is inserted into the fixing slot hole.

And/or the fixing structure includes a fixing snap protrusion and a fixing snap slot. The fixing snap protrusion is disposed to protrude from a surface of the insulating end cap along a direction perpendicular to the length direction. The fixing snap slot is disposed on the insulating shell, and the fixing snap protrusion is snapped into the fixing snap slot.

In some embodiments, a second positioning structure is formed between the insulating shell and the first carrier board, and the second positioning structure is configured to position a relative position between the first carrier board and the insulating shell.

In some embodiments, the interface assembly comprises an interface housing, a third carrier board and an interface pin.

The interface housing includes a guide cavity. The guide cavity is disposed to penetrate the interface housing along the length direction, and one end of the interface housing along the length direction is sleeved on the first end of the insulating shell.

The third carrier board is inserted into the guide cavity along the length direction, the third carrier board and the first carrier board being of an integral structure.

The interface pin is formed on a surface of the third carrier board, the interface pin being electrically connected to the antenna assembly.

In some embodiments, the insulating shell includes a supporting structure. The supporting structure is inserted into the guide cavity along the length direction, and the third carrier board is fixedly connected to the supporting structure.

In some embodiments, the antenna assembly further comprises a wireless module. The interface pin and the first antenna are electrically connected to the wireless module. The wireless module is disposed at a position of the first carrier board close to the third carrier board along the length direction, or the wireless module is disposed at a position of the third carrier board close to the first carrier board along the length direction.

According to the foregoing embodiment, the wireless adapter includes the housing assembly, the interface assembly, and the antenna assembly. The accommodation cavity is formed inside the housing assembly. The interface assembly is disposed at one end of the housing assembly along the length direction of the wireless adapter. The antenna assembly is disposed in the accommodation cavity and electrically connected to the interface assembly. The antenna assembly includes the first antenna and the second antenna, and the plane in which the first antenna is located intersects with the plane in which the second antenna is located. Based on a composite antenna formed by the first antenna and the second antenna inside the adapter, a structural form in which the plane in which the first antenna is located intersects with the plane in which the second antenna is located enables the two antennas to complement each other in directivity. Therefore, the antenna operating bandwidth and operating efficiency can be effectively improved, and a signal coverage range can be expanded. Meanwhile, full utilization of a limited internal space of the adapter can also be achieved, thereby creating conditions for reducing an overall size of the adapter.

### BRIEF DESCRIPTION OF THE DRAWINGS

FIG. 1 is a schematic diagram illustrating an external contour structure of a wireless adapter according to an embodiment of the present disclosure;

FIG. 2 is a schematic sectional diagram illustrating a structure of the wireless adapter in FIG. 1 along an A-A direction;

FIG. 3 is a schematic exploded diagram (I) illustrating a structure of a wireless adapter according to an embodiment of the present disclosure;

FIG. 4 is a schematic exploded diagram (II) illustrating a structure of a wireless adapter according to an embodiment of the present disclosure;

FIG. 5 is a schematic exploded diagram (III) illustrating a structure of a wireless adapter according to an embodiment of the present disclosure;

FIG. 6 is a schematic exploded diagram (IV) illustrating a structure of a wireless adapter according to an embodiment of the present disclosure;

FIG. 7 is a comparison diagram illustrating antenna bandwidth tests between a wireless adapter according to an embodiment of the present disclosure and an existing wireless adapter;

FIG. 8 is a comparison diagram illustrating antenna efficiency tests between a wireless adapter according to an embodiment of the present disclosure and an existing wireless adapter;

FIG. 9 is a comparison diagram illustrating horizontal sectional directions between a wireless adapter according to an embodiment of the present disclosure and an existing wireless adapter.

In the figures:
100, housing assembly; 100 a, accommodation cavity; 110, insulating shell; 110 a, fixing slot hole; 110b, fixing snap slot; 110c, supporting structure; 110d, light-guiding structure; 120, insulating end cap; 120a, positioning protrusion; 120b, fixing protrusion; 120c, fixing snap protrusion;
200, interface assembly; 210, interface housing; 210 a, guide cavity; 220, third carrier board; 230, interface pin;
300, antenna assembly; 310, first antenna; 320, second antenna; 330, elastic member;
400, carrier board assembly; 410, first carrier board; 410 a, protruding structure; 420, second carrier board; 420a, positioning through hole.

### DETAILED DESCRIPTION

The present application is further described in detail below through specific embodiments in conjunction with the accompanying drawings. Similar components in different embodiments are denoted by associated similar component reference numerals. In the following embodiments, many details are described to enable a better understanding of the present application. However, those skilled in the art can readily recognize that some of these features can be omitted under different circumstances, or can be replaced by other components, materials, or methods. In some cases, certain operations related to the present disclosure are not shown or described in the specification in order to avoid obscuring the core aspects of the present disclosure with excessive description. For those skilled in the art, detailed descriptions of these related operations are unnecessary, since the relevant operations can be fully understood based on the descriptions in the specification and the general technical knowledge in the art.

Furthermore, the characteristics, operations, or features described in the specification can be combined in any suitable manner to form various embodiments. Simultaneously, the steps or actions in the method descriptions can also be sequentially exchanged or adjusted in a manner obvious to those skilled in the art. Therefore, the various sequences in the specification and the drawings are provided merely for clearly describing a certain embodiment and do not imply that such an order must be followed, unless otherwise specified that a particular order is required.

Reference numerals such as “first,” “second,” and the like used for components in the present disclosure are merely for distinguishing the described objects and do not carry any sequential or technical meaning. The terms “connected” and “coupled” as used in the present disclosure, unless otherwise specified, include both direct and indirect connections (couplings).

Common wireless adapters, limited by factors such as its own structural dimensions and application scenarios, generally include a single onboard antenna disposed in a housing of the adapter (e.g., an antenna structure formed by etching an antenna circuit on a rigid printed circuit board (PCB)). Through the onboard antenna, the wireless adapter is capable of transmitting and receiving signals within a certain frequency band. However, such a configuration also results in a series of problems for the wireless adapter, such as a narrow frequency bandwidth, a small signal coverage range, a short signal transmission distance, and poor directivity.

The wireless adapter provided in the present disclosure forms a composite antenna inside the adapter by means of a first antenna and a second antenna. Through a structural form in which a plane in which the first antenna is located intersects with a plane in which the second antenna is located, complementarity of directivity between the two antennas can be achieved. Compared with related wireless adapters, the wireless adapter provided in the present disclosure has a wider frequency bandwidth, a larger signal coverage range, and a longer signal transmission distance.

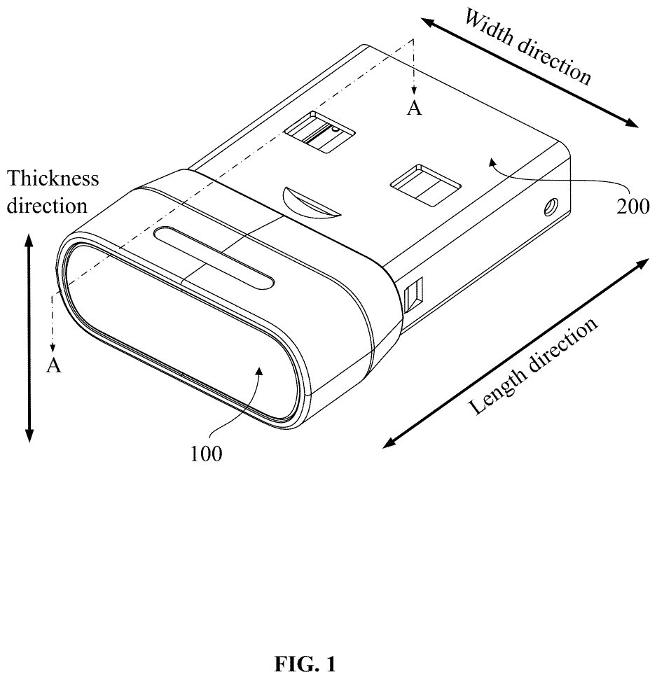

Referring to FIGS. 1 to 9, an embodiment of the present disclosure provides a wireless adapter, which may be applied to wearable devices such as earphones, smart glasses, watches, and wristbands to support data and information interaction between the wearable devices and external devices such as mobile phones and computers. The wireless adapter includes a housing assembly 100, an interface assembly 200, an antenna assembly 300, and other functional components as required.

For a clearer and more detailed description of the wireless adapter, please refer to FIG. 1. Based on an overall structural configuration of the wireless adapter, three mutually orthogonal directions are defined, i.e., a length direction, a thickness direction, and a width direction. The length direction refers to a plugging and unplugging operation direction of the wireless adapter during use.

Referring to FIGS. 1 to 6, the housing assembly 100 and the interface assembly 200 are connected and arranged substantially along the length direction to form an overall external contour structure of the wireless adapter. It can be understood that the interface assembly 200 is disposed at one end of the housing assembly 100 along the length direction. The interface assembly 200 mainly serves as a signal and structural connection carrier between the wireless adapter and a wearable device. For example, through the interface assembly 200, the wireless adapter can be inserted into the wearable device, thereby establishing the signal and structural connection relationship between the wearable device and the wireless adapter.

Merely by way of example, the interface assembly 200 may be an interface structure such as a Type-C interface, a USB interface, or a Lightning interface, which may be selectively configured as required and is not limited thereto.

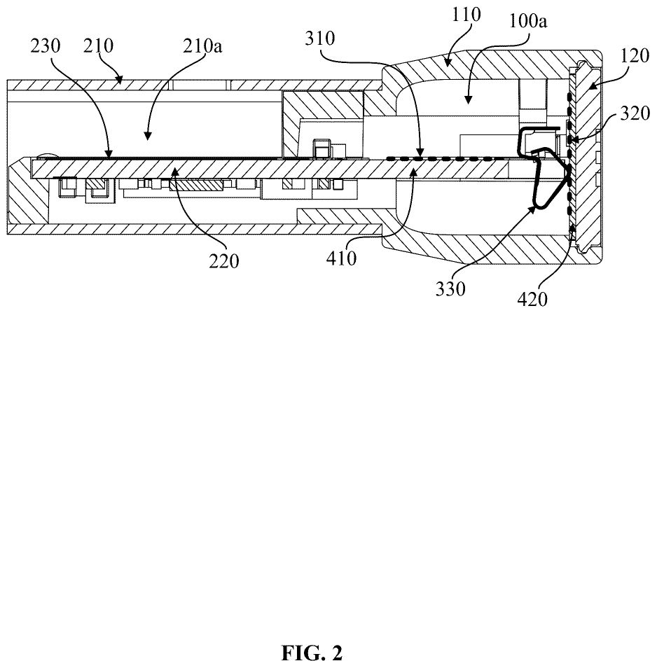

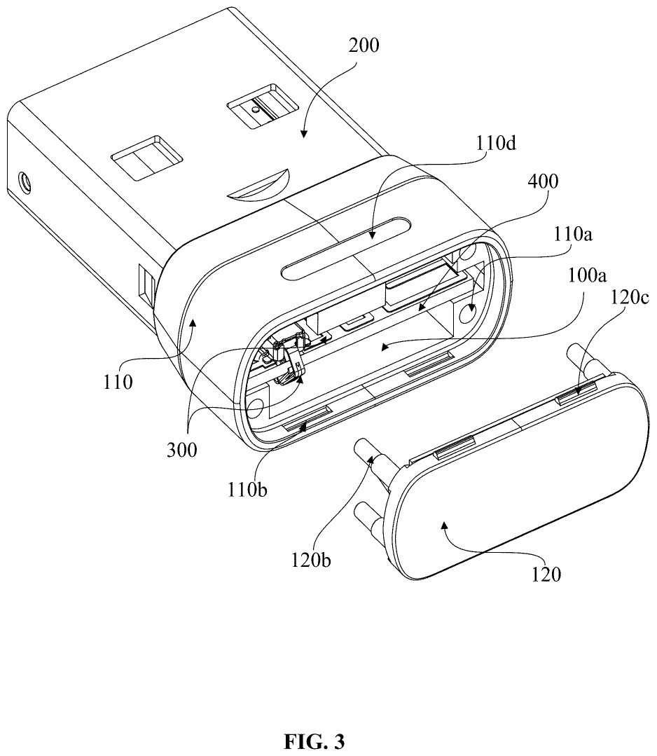

Referring to FIGS. 2 and 3, the accommodation cavity 100a is formed inside the housing assembly 100, and the antenna assembly 300 is disposed in the accommodation cavity 100a and electrically connected to the interface assembly 200. Through the antenna assembly 300, functions such as transmission, reception, conversion, and processing of data information (or wireless signals) can be implemented, so that when the wireless adapter is applied to a wearable device, a data information interaction relationship can be established between the wearable device and an external device.

In some embodiments, referring to FIGS. 2 to 5, the antenna assembly 300 includes a first antenna 310, a second antenna 320, and a wireless module (not shown in figures).

The wireless module is configured to implement functions such as transmission, conversion, and processing of data information. The interface assembly 200, the first antenna 310, and the second antenna 320 are electrically connected to the wireless module.

Merely by way of example, the wireless module may include circuits or components of different functional types such as a radio frequency chip, a microcontroller, a filter, and a sensor. The wireless module is electrically connected and disposed between the interface assembly 200 and the first antenna 310 (and the second antenna 320).

In some embodiments, the wireless module may also be a collection of functional devices independent of the antenna assembly 300 and cooperating with the antenna assembly 300. Detailed descriptions thereof are omitted herein.

The first antenna 310 and the second antenna 320 are disposed in the accommodation cavity 100a in such a manner that the planes in which the first antenna 310 and the second antenna 320 are respectively located intersect with each other, i.e., the plane in which the first antenna 310 is located intersects with the plane in which the second antenna 320 is located.

Merely by way of example, the plane in which the first antenna 310 is located and the plane in which the second antenna 320 is located are perpendicular to each other in the accommodation cavity 100a or in a three-dimensional space. For example, the plane in which the first antenna 310 is located may be a plane perpendicular to the thickness direction, and the plane in which the second antenna 320 is located may be a plane perpendicular to the length direction or the width direction.

Merely by way of example, the plane in which the first antenna 310 is located and the plane in which the second antenna 320 is located intersect obliquely with each other in the accommodation cavity 100a or in a three-dimensional space. For example, the plane in which the first antenna 310 is located may be the plane perpendicular to the thickness direction, and an included angle between the plane in which the second antenna 320 is located and the plane in which the first antenna 310 is located may be an acute angle or an obtuse angle.

It should be noted that the description of “the plane in which the first antenna 310 is located” and “the plane in which the second antenna 320 is located” in the present disclosure is merely introduced for clearly and thoroughly describing a relative spatial positional relationship between the first antenna 310 and the second antenna 320. It can be understood that, depending on different structural forms presented by the first antenna 310 and the second antenna 320, the plane in which the first antenna 310 is located and the plane in which the second antenna 320 is located may be a virtual plane or a visible plane.

By means of a composite antenna structure formed by the first antenna 310 and the second antenna 320 in the accommodation cavity 100a, and through a structural form in which the plane in which the first antenna 310 is located intersects with the plane in which the second antenna 320 is located, complementarity of directivity between the first antenna 310 and the second antenna 320 can be achieved. In cooperation with the wireless module, the antenna assembly 300 or the wireless adapter is enabled to transmit and receive signals within a certain frequency band (for example, Bluetooth signals in a frequency band of 2.4 GHz to 2.5 GHz).

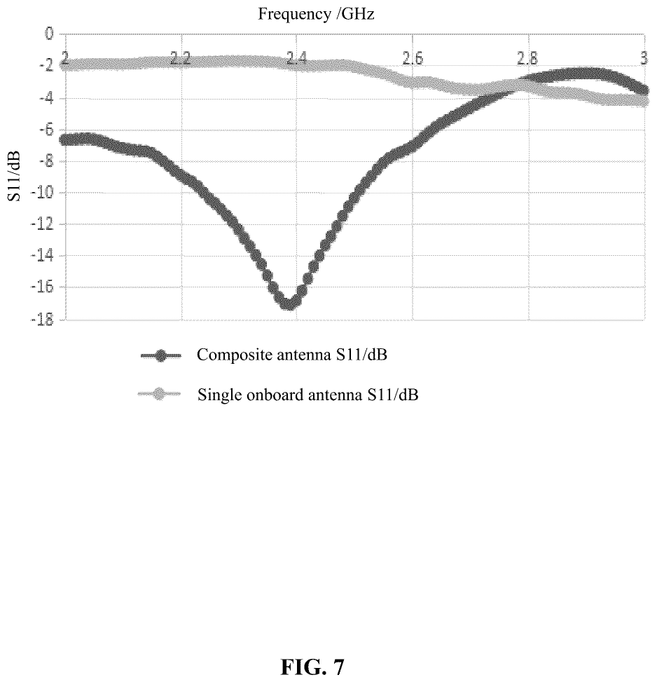

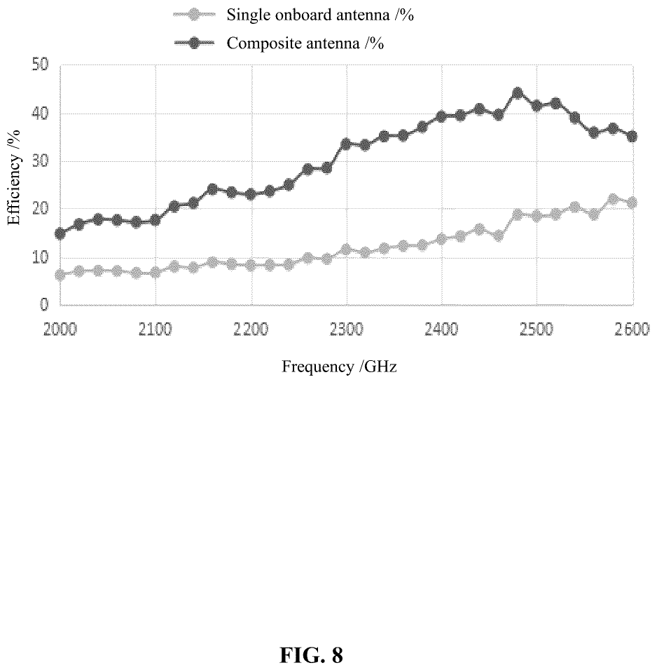

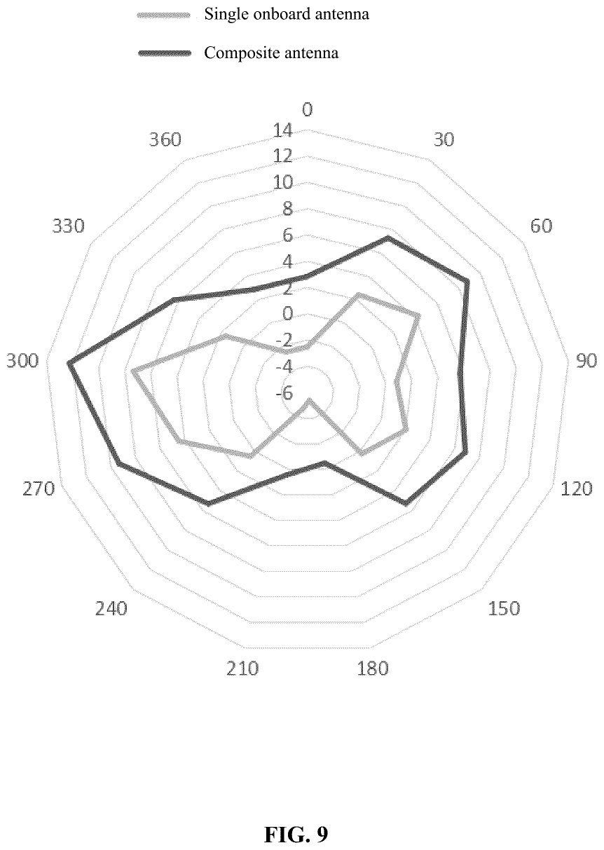

Meanwhile, performance testing and comparative analysis are conducted between the wireless adapter adopting the composite antenna structure in the embodiments of the present disclosure and the wireless adapter adopting a single-antenna structure in the related art. FIG. 7 indicates that an operating bandwidth of the composite antenna is significantly higher than that of the single antenna. FIG. 8 indicates that an operating efficiency of the composite antenna is significantly higher than that of the single antenna. FIG. 9 indicates that a signal coverage range of the composite antenna is significantly larger than that of the single antenna.

Based on the foregoing, compared with the existing wireless adapters, the wireless adapter provided in the embodiments of the present disclosure, by means of a composite antenna structure formed by the first antenna 310 and the second antenna 320, is capable of effectively improving an operating bandwidth and an operating efficiency of the antenna assembly 300 or the wireless adapter, expanding a signal coverage range, extending a signal transmission distance, and enhancing a signal strength.

In some embodiments, referring to FIGS. 2 to 5, the wireless adapter further comprises a carrier board assembly 400 disposed in the accommodation cavity 100a. The carrier board assembly 400 includes a first carrier board 410 and a second carrier board 420 fixedly connected to the housing assembly 100. The first antenna 310 is formed on a surface of the first carrier board 410, and the second antenna 320 is formed on a surface of the second carrier board 420. For example, the first antenna 310 and the second antenna 320 are disposed on corresponding carrier boards in forms such as etching, printing, or attachment. The first carrier board 410 and the second carrier board 420 are arranged to intersect with each other in the accommodation cavity 100a, such that a plane in which the first antenna 310 is located intersects with a plane in which the second antenna 320 is located.

Merely by way of example, the first carrier board 410 is disposed in the accommodation cavity 100a perpendicular to the thickness direction of the wireless adapter. The second carrier board 420 is disposed in the accommodation cavity 100a perpendicular to the length direction of the wireless adapter and is located on a side of the first carrier board 410 away from the interface assembly 200 along the length direction.

By disposing the first antenna 310 and the second antenna 320 on different carrier boards, the first carrier board 410 and the second carrier board 420 enable the plane in which the first antenna 310 is located and the plane in which the second antenna 320 is located to stably maintain an intersecting state with each other. Meanwhile, by adjusting the relative position between the first carrier board 410 and the second carrier board 420 in the accommodation cavity 100a, the relative position between the first antenna 310 and the second antenna 320 can be adjusted and set, so as to adapt to a structural configuration of an internal space of the housing assembly 100 or assembly requirements of the antenna assembly 300.

In some embodiments, the second carrier board 420 may be omitted, and the second antenna 320 is fixedly disposed on the inner wall of the housing assembly 100 in a form such as etching, printing, or attachment (i.e., the inner wall intersecting with the plane in which the first carrier board 410 or the first antenna 310 is located). The plane in which the first antenna 310 is located and the plane in which the second antenna 320 is located can also intersect with each other. Therefore, a number of functional components in the wireless adapter may be effectively reduced, which is advantageous for enhancing structural compactness of the wireless adapter and for fully utilizing an internal structural space of the housing assembly 100.

In some embodiments, a material hardness of the first carrier board 410 is set to be greater than a material hardness of the second carrier board 420. For example, the first carrier board 410 adopts a rigid printed circuit board (PCB), and the second carrier board 420 adopts a flexible printed circuit board (Flexible Printed Circuit, abbreviated as FPC).

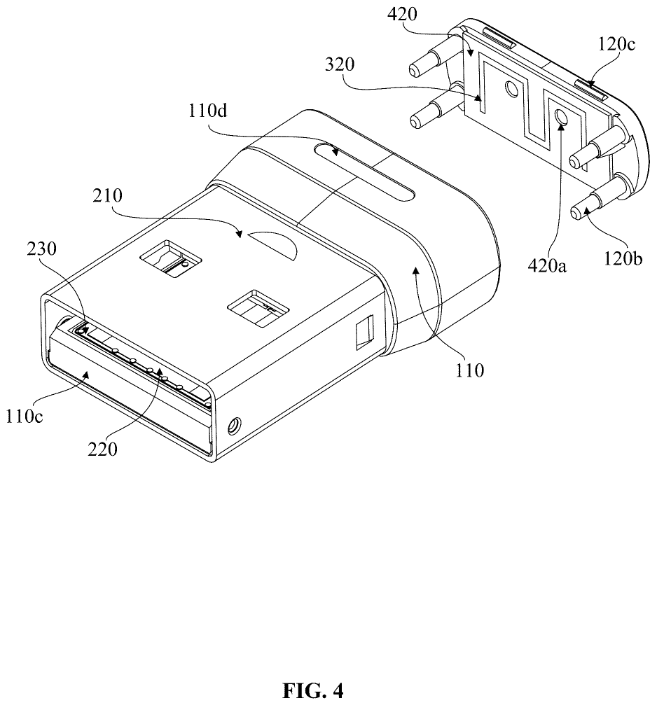

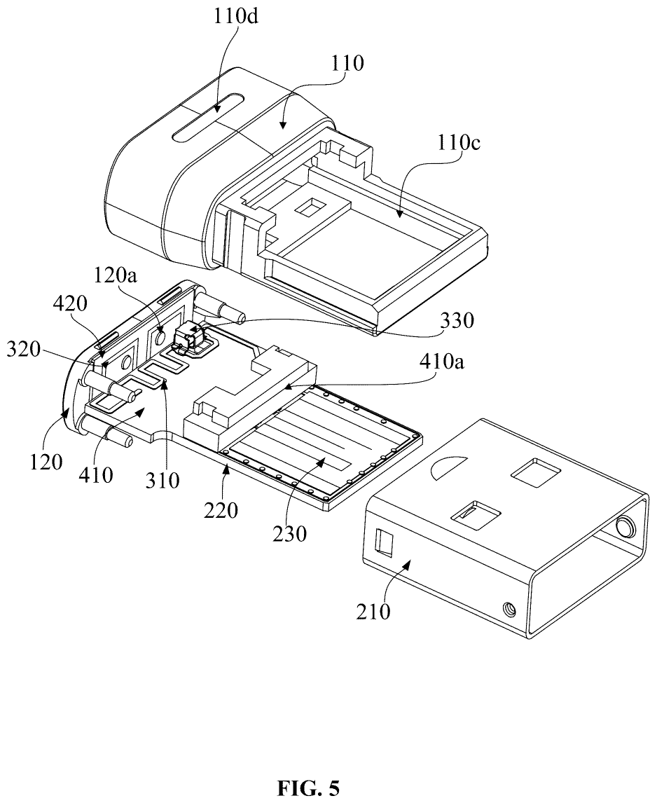

By virtue of relatively stable material characteristics of the first carrier board 410, referring to FIG. 2, FIG. 3, and FIG. 5, the first carrier board 410 may be used as a structural supporting carrier for a main portion of the antenna assembly 300 (for example, the wireless module and the first antenna 310). In addition, through a structural connection relationship between the first carrier board 410 and the housing assembly 100, the main portion of the antenna assembly 300 is fixed in the accommodation cavity 100a. Referring to FIG. 4, by utilizing relatively flexible material characteristics of the second carrier board 420, the second carrier board 420 (together with the second antenna 320) may be fixed on the inner wall of the housing assembly 100 (i.e., a cavity wall of the accommodation cavity 100a) in a form such as attachment.

Based on differences in the material hardness between the second carrier board 420 and the first carrier board 410 and differences in structural connection forms with the housing assembly 100, on one hand, a spatial position of the second carrier board 420 and the second antenna 320 may be adaptively adjusted according to an internal spatial structure of the housing assembly 100, so as to ensure that the plane in which the first antenna 310 is located intersects with the plane in which the second antenna 320 is located.

On the other hand, by fixing the second carrier board 420 (together with the second antenna 320) on the inner wall of the housing assembly 100, an occupation of a limited space of the accommodation cavity 100a by the second carrier board 420 may be effectively reduced, or an internal space of the housing assembly 100 may be fully utilized, thereby creating favorable conditions for enhancing structural compactness of the wireless adapter and reducing an overall size of the wireless adapter, so that the wireless adapter may meet application requirements of increasingly miniaturized wearable devices.

In some embodiments, the first carrier board 410 and the second carrier board 420 may also be made of the same material. For example, both the first carrier board 410 and the second carrier board 420 may adopt the rigid printed circuit boards. Based on a structural form of the housing assembly 100, the first carrier board 410 and the second carrier board 420 may be fixedly connected to the housing assembly 100 independently of each other, or the first carrier board 410 and the second carrier board 420 may be fixedly disposed as an integral structure (for example, the second carrier board 420 is fixed on a side edge of the first carrier board 410 in a form intersecting with the first carrier board 410). Therefore, not only may consistency of materials of the carrier board assembly 400 be ensured, creating conditions for reducing configuration costs of the wireless adapter, but also different structural forms of the antenna assembly 300 may be constructed and formed.

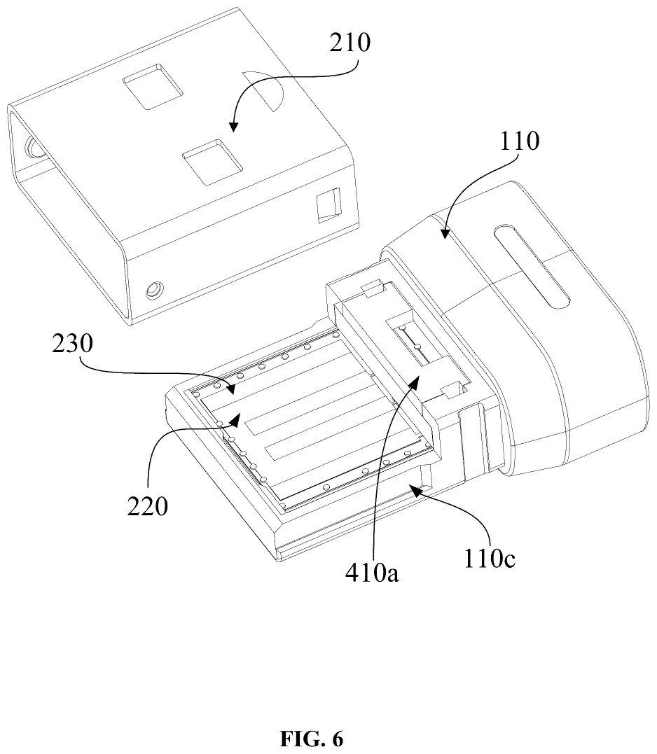

It should be noted that bold dashed lines in FIG. 2 represent the first antenna 310 and the second antenna 320. The first antenna 310 shown in FIG. 5 and the second antenna 320 shown in FIG. 6 are merely used to illustrate positions where the first antenna 310 and the second antenna 320 are disposed, and do not represent structural dimensions, shapes, or other characteristics of the first antenna 310 and the second antenna 320.

In some embodiments, referring to FIG. 2 to FIG. 5, the housing assembly 100 includes an insulating shell 110 and an insulating end cap 120. The insulating shell 110 is generally a housing structure having a preset length in a length direction. For ease of distinction and description, two opposite ends of the insulating shell 110 in the length direction are defined as a first end and a second end of the insulating shell 110, respectively. The first carrier board 410 is fixed inside the insulating shell 110, and the interface assembly 200 is disposed at the first end of the insulating shell 110.

The insulating end cap 120 is disposed at the second end of the insulating shell 110, so that the accommodation cavity 100a is enclosed and formed between the insulating shell 110 and the insulating end cap 120. Merely by way of example, the insulating end cap 120 may be fixedly disposed at the second end of the insulating shell 110 in a form such as bonding, snapping, locking, or welding. For ease of distinction and description, a wall surface of the insulating end cap 120 facing the insulating shell 110 in the length direction or serving as a cavity wall of the accommodation cavity 100a is defined as the inner wall of the insulating end cap 120. The second carrier board 420 is stacked and fixed on the inner wall of the insulating end cap 120. For example, a second carrier board 420 adopting a flexible printed circuit board may be adhesively fixed on the inner wall of the insulating end cap 120.

Therefore, by assembling the housing assembly 100 through a combination of the insulating shell 110 and the insulating end cap 120, and by fixedly disposing the first carrier board 410 (together with the first antenna 310) and the second carrier board 420 (together with the second antenna 320) on different components of the housing assembly 100, an assembly difficulty of the antenna assembly 300 and even the wireless adapter may be effectively reduced. In addition, targeted disassembly, maintenance, or replacement may be performed on a component to which the first antenna 310 belongs and a component to which the second antenna 320 belongs as required.

In some embodiments, in a case where the second carrier board 420 is omitted, the second antenna 320 may be disposed on an inner wall of the insulating end cap 120, for example, formed on the inner wall of the insulating end cap 120 in a form such as etching, printing, or attachment. In this way, by using the housing assembly 100 as a structural supporting carrier for the antenna, a structural space of the housing assembly 100 may be fully utilized.

In some embodiments, referring to FIG. 2, FIG. 3, and FIG. 5, the antenna assembly 300 further includes a feed point structure. The feed point structure includes an elastic member 330 (e.g., an elastic conductive body such as an elastic flap or an elastic column capable of elastic deformation). The elastic member 330 has a fixed end fixed relative to the first carrier board 410 in a length direction and a free end movable relative to the first carrier board 410. The fixed end of the elastic member 330 is fixed to the first carrier board 410 and is in the electrical contact connection with the first antenna 310 disposed on the first carrier board 410.

When the insulating end cap 120 is assembled to the second end of the insulating shell 110, the insulating end cap 120 may press a free end of the elastic member 330 along the length direction, so that the free end of the elastic member 330 stably maintains an elastic electrical contact relationship with the second antenna 320 disposed on the second carrier board 420 or the insulating end cap 120. Therefore, by means of the elastic member 330 or the feed point structure, a stable electrical contact connection relationship may be established between the first antenna 310 and the second antenna 320, so that the first antenna 310 and the second antenna 320 are combined to form a monopole antenna structure having a function of directivity complementarity.

Merely by way of example, the first antenna 310 and the wireless module are disposed on the first carrier board 410 in an electrically connected manner, and the second antenna 320 is electrically connected to the first antenna 310 through the feed point structure (specifically, the elastic member 330). In this case, the second antenna 320 is equivalent to an antenna portion formed by the first antenna 310 extending in a different direction.

In some embodiments, the feed point structure may also adopt other suitable structures. For example, the feed point structure may include a conductive material layer disposed on an end surface of the first carrier board 410 and electrically connected to the first antenna 310. As another example, the feed point structure may include a conductive wire connected between the first antenna 310 and the second antenna 320.

In some embodiments, based on different relative positions of the wireless module, the first antenna 310, and the second antenna 320 in the accommodation cavity 100a, the second antenna 320 may be in direct electrical contact connection with the wireless module or may be electrically connected to the wireless module through the feed point structure. For example, both the first antenna 310 and the second antenna 320 may adopt monopole antenna structures and be electrically connected to the wireless module, so that by means of a structural form in which the planes in which the first antenna 310 and the second antenna 320 are located intersect with each other, complementarity of directivity between the two antennas may be achieved.

In some embodiments, referring to FIG. 3 to FIG. 5, a first positioning structure is formed between the insulating end cap 120 and the second carrier board 420. The first positioning structure includes a positioning protrusion 120a and a positioning through hole 420a. The positioning protrusion 120a is disposed to protrude from the inner wall of the insulating end cap 120 along the length direction, and the positioning through hole 420a is disposed to penetrate the second carrier board 420 along the length direction. A count of the positioning protrusions 120a and the positioning through holes 420a may be one or a plurality, and a plurality of positioning protrusions 120a correspond one-to-one to a plurality of positioning through holes 420a.

During a process in which the second carrier board 420 is stacked and fixed on the inner wall of the insulating end cap 120, an alignment relationship between the positioning protrusions 120a and the positioning through holes 420a may be utilized, so that each positioning protrusion 120a is inserted through a corresponding positioning through hole 420a. In this way, the second carrier board 420 may be quickly and accurately positioned on the inner wall of the insulating end cap 120, so that the second antenna 320 may be assembled and formed on the insulating end cap 120. In addition, stability of a structural connection between the second carrier board 420 and the insulating end cap 120 may be enhanced, thereby preventing positional deviation of the second antenna 320 on the insulating end cap 120 that may affect an alignment relationship between the second antenna 320 and the feed point structure (or the first antenna 310, the wireless module, and the like).

In some embodiments, the first positioning structure may also adopt other suitable structures. For example, a groove structure adapted to a contour shape of the second carrier board 420 may be provided on the inner wall of the insulating end cap 120, and the second carrier board 420 may be accommodated in the groove structure to achieve quick positioning between the second carrier board 420 and the insulating end cap 120. As another example, a notch structure may be provided at a contour edge position of the second carrier board 420, and positioning between the second carrier board 420 and the insulating end cap 120 may be achieved by an alignment relationship between the positioning protrusion 120a and the notch structure.

In other embodiments, based on differences in material or size of the second carrier board 420, the positioning protrusion 120a may also be disposed to protrude from the surface of the second carrier board 420, and a through hole or a slot hole for insertion of the positioning protrusion 120a may be provided on the insulating end cap 120. For example, when the second carrier board 420 adopts a rigid printed circuit board, the positioning protrusion 120a may be disposed to protrude from the surface of the second carrier board 420.

In some embodiments, referring to FIG. 3 to FIG. 5, a fixing structure is disposed between the insulating shell 110 and the insulating end cap 120. The fixing structure includes a fixing protrusion 120b and a fixing slot hole 110a that are aligned and fitted with each other, and a fixing snap protrusion 120c and a fixing snap slot 110b that are aligned and fitted with each other. The fixing protrusion 120b is disposed to protrude from the inner wall of the insulating end cap 120 along the length direction and is located at an edge position of the second carrier board 420 (e.g., a plurality of fixing protrusions 120b are spaced apart around the second antenna 320). The fixing slot hole 110a is disposed inside the insulating shell 110 and corresponds one-to-one to the fixing protrusion 120b. The fixing snap protrusion 120c is disposed to protrude from the surface of the insulating end cap 120 in a thickness direction or a width direction. For example, a plurality of fixing snap protrusions 120c are spaced apart on the surface of the insulating end cap 120 in the thickness direction. The fixing snap slot 110b is disposed inside the insulating shell 110 corresponding to the positions of the fixing snap protrusions 120c.

During a process in which the insulating end cap 120 is assembled to the second end of the insulating shell 110, an alignment relationship between the fixing protrusions 120b and the fixing slot holes 110a may be utilized, so that each fixing protrusion 120b is aligned and inserted into a corresponding fixing slot hole 110a, thereby achieving positioning between the insulating shell 110 and the insulating end cap 120. Meanwhile, by means of an alignment and snapping relationship between the fixing snap protrusions 120c and the fixing snap slots 110b, the insulating end cap 120 may be stably fixed to the insulating shell 110. Since the fixing structure is formed inside the housing assembly 100 (specifically, in the accommodation cavity 100a), integrity of an external contour structure of the housing assembly 100 or the wireless adapter may be ensured, thereby creating favorable conditions for improving an aesthetic appearance of the wireless adapter.

In some embodiments, the fixing structure may also adopt other suitable structures. For example, the fixing protrusions 120b and the fixing slot holes 110a may be omitted, and quick positioning between the insulating shell 110 and the insulating end cap 120 may be achieved by means of a contour shape matching relationship between a second-end port of the insulating shell 110 and the insulating end cap 120. As another example, the fixing snap slots 110b and the fixing snap protrusions 120c may be omitted, and the insulating end cap 120 may be fixed to a second end of the insulating shell 110 by means such as bonding or welding. Various implementations of such configurations are not described herein in detail.

In some embodiments, referring to FIG. 1, a second positioning structure is formed between the insulating shell 110 and the first carrier board 410. The second positioning structure may include a protruding structure 410a disposed to protrude from the surface of the first carrier board 410 in a thickness direction. The insulating shell 110 is provided with a corresponding structure configured to be aligned and fitted with the second positioning structure (for example, in a manner of snapping or accommodating).

By means of the second positioning structure, a position of the first carrier board 410 inside the insulating shell 110 or in the accommodation cavity 100a may be restricted and positioned, so as to ensure that the first carrier board 410 and related components (e.g., the first antenna 310, the elastic member 330, and the wireless module) may be stably disposed in the accommodation cavity 100a.

In some embodiments, the wireless module may be concealed between the protruding structure 410a and the first carrier board 410, so that the protruding structure 410a may provide structural protection for the wireless module.

In some embodiments, referring to FIG. 2 to FIG. 6, the interface assembly 200 includes an interface housing 210, a third carrier board 220, and an interface pin 230. An interior of the interface housing 210 defines a guide cavity 210a disposed to penetrate the interface housing 210 along a length direction. One end of the interface housing 210 in the length direction is sleeved on a first end of the insulating shell 110 (it can also be understood that one end of the insulating shell 110 is inserted into the guide cavity 210a). The third carrier board 220 is inserted into the guide cavity 210a along the length direction, and the third carrier board 220 and the first carrier board 410 are of an integral structure (it can be understood that the same carrier board is structurally and functionally divided along the length direction to form the first carrier board 410 and the third carrier board 220). The interface pin 230 is formed on a surface of the third carrier board 220 and is electrically connected to the antenna assembly 300 (specifically, the wireless module).

By selectively configuring structural forms or functional implementations of the interface housing 210 or the interface pin 230, the interface assembly 200 may be constructed as an interface structure such as a Type-C interface, a USB interface, or a Lightning interface, so that the wireless adapter may be inserted into a wearable device through the interface assembly 200. By configuring the first carrier board 410 and the third carrier board 220 as an integral structure, a count of components of the wireless adapter may be effectively reduced, and structural compactness and stability of the wireless adapter may be enhanced.

In some embodiments, the wireless module may be disposed at a junction or boundary position between the first carrier board 410 and the third carrier board 220. For example, the wireless module may be disposed at a position of the first carrier board 410 close to the third carrier board 220 along the length direction, or the wireless module may be disposed at a position of the third carrier board 220 close to the first carrier board 410 along the length direction. Therefore, by means of the arrangement of the wireless module, the interface pin 230 and the first antenna 310, as well as their respective positions, may be clearly distinguished.

In some embodiments, referring to FIG. 5 and FIG. 6, the insulating shell 110 further includes a supporting structure 110c. The supporting structure 110c is disposed to protrude from a first end of the insulating shell 110 along a length direction and is inserted into the guide cavity 210a along the length direction. The third carrier board 220 is fixedly connected to the supporting structure 110c.

By means of the supporting structure 110c, a stable structural connection relationship may be established between the interface housing 210 and the insulating shell 110, and the third carrier board 220 (together with the interface pin 230) may be stably positioned in the guide cavity 210a. In specific implementations, the supporting structure 110c may adopt a window structure or a frame structure, so as to avoid structural interference of the supporting structure 110c with the interface pin 230 and to ensure that the wireless adapter or the interface assembly 200 may establish a signal connection relationship with a wearable device through the interface pin 230.

In some embodiments, a second positioning structure may be formed between a junction position of the first carrier board 410 and the third carrier board 220 and the supporting structure 110c, so that by means of the second positioning structure, the first carrier board 410 may be simultaneously positioned and fixed in the accommodation cavity 100a, and the third carrier board 220 may be positioned and fixed on the supporting structure 110c, thereby creating favorable conditions for rapid assembly and forming of the wireless adapter.

In some embodiments, referring to FIG. 3 to FIG. 5, the insulating shell 110 further includes a light-guiding structure 110d. The light-guiding structure 110d may be a light-transmitting or light-guiding material body disposed to penetrate a side wall of the insulating shell 110 in a thickness direction, or may be a through-hole structure penetrating the side wall of the insulating shell 110. Correspondingly, a light-emitting element (for example, an LED bead or a light-emitting diode) may be disposed at a position of the first carrier board 410 corresponding to the light-guiding structure 110d. By means of the light-guiding structure 110d, light emitted from the light-emitting element may be guided to an exterior of the wireless adapter, so that a status of the wireless adapter may be displayed.

It should be noted that a wearable device is merely one specific application scenario of the wireless adapter provided in the present disclosure. The wireless adapter may also be applied to other devices. For example, by inserting the wireless adapter into a computer device, data and information interaction may be achieved between the computer device and related devices (e.g., a mouse, a keyboard, or other electronic products). It can be understood that the application scenarios do not constitute a limitation on the wireless adapter of the embodiments of the present disclosure.

The foregoing description of specific examples is provided merely to assist in understanding the present disclosure and is not intended to limit the present disclosure. Those skilled in the art in the technical field to which the present disclosure pertains may, based on the spirit of the present disclosure, make various simple deductions, modifications, or substitutions.

1. A wireless adapter, comprising:
a housing assembly including an accommodation cavity, the accommodation cavity being formed inside the housing assembly;
an interface assembly disposed at one end of the housing assembly along a length direction of the wireless adapter;
an antenna assembly disposed in the accommodation cavity, the antenna assembly being electrically connected to the interface assembly, the antenna assembly including a first antenna and a second antenna, and a plane in which the first antenna is located intersecting with a plane in which the second antenna is located;
wherein the housing assembly comprises:
an insulating shell including a first end and a second end opposite to each other along the length direction, the interface assembly being disposed at the first end of the insulating shell; and
an insulating end cap disposed at the second end of the insulating shell, the accommodation cavity being formed between the insulating shell and the insulating end cap, and the second antenna is located on an inner wall of the insulating end cap.

2. The wireless adapter of claim 1, wherein the plane in which the first antenna is located is perpendicular to the plane in which the second antenna is located.

3. The wireless adapter of claim 1, wherein the antenna assembly further comprises a wireless module, the wireless module is electrically connected to the first antenna, the second antenna, and the interface assembly, and the wireless module, the first antenna, and the second antenna cooperate with each other to enable the wireless adapter to transmit and receive signals within a certain frequency band.

4. The wireless adapter of claim 1, further comprising a carrier board assembly disposed in the accommodation cavity, the carrier board assembly including a first carrier board and a second carrier board, the first carrier board and the second carrier board being fixedly connected to the housing assembly, the first antenna being formed on a surface of the first carrier board, and the second antenna being formed on a surface of the second carrier board.

5. The wireless adapter of claim 4, wherein a material hardness of the first carrier board is greater than a material hardness of the second carrier board, and the second carrier board is abutted and fixed to an inner wall of the housing assembly.

6. The wireless adapter of claim 5, wherein the first carrier board is a rigid printed circuit board, and the second carrier board is a flexible printed circuit board.

7. The wireless adapter of claim 4, wherein the first carrier board being fixed inside the insulating shell; and
the second carrier board is stacked and fixed on an inner wall of the insulating end cap.

8. The wireless adapter of claim 7, wherein a first positioning structure is formed between the insulating end cap and the second carrier board, and the first positioning structure is configured to position a relative position between the second carrier board and the insulating end cap.

9. The wireless adapter of claim 8, wherein the first positioning structure includes a positioning protrusion and a positioning through hole, the positioning protrusion is disposed to protrude from the inner wall of the insulating end cap along the length direction, the positioning through hole is disposed to penetrate the second carrier board along the length direction, and the positioning protrusion is inserted through the positioning through hole to position the second carrier board and the insulating end cap.

10. The wireless adapter of claim 1, further comprising a carrier board assembly disposed in the accommodation cavity, the carrier board assembly including a first carrier board, the first carrier board being fixedly connected to the housing assembly, the first antenna being formed on a surface of the first carrier board, and the second antenna being formed on an inner wall of the housing assembly.

11. The wireless adapter of claim 10, wherein
the first carrier board being fixed inside the insulating shell; and
the second antenna is formed on an inner wall of the insulating end cap.

12. The wireless adapter of claim 20 wherein the antenna assembly further comprises a feed point structure, the feed point structure being in electrical contact connection with the first antenna and the second antenna.

13. The wireless adapter of claim 12, wherein the feed point structure comprises an elastic member, the elastic member includes a fixed end fixed relative to the first carrier board along the length direction and a free end movable relative to the first carrier board along the length direction, the fixed end of the elastic member is fixedly connected to the first carrier board and in electrical contact connection with the first antenna, and the free end of the elastic member is in elastic and electrical contact with the second antenna.

14. The wireless adapter of claim 17, wherein a fixing structure is disposed between the insulating shell and the insulating end cap, and the fixing structure is arranged around the second antenna and configured to fix the insulating end cap to the insulating shell.

15. The wireless adapter of claim 14, wherein
the fixing structure includes a fixing protrusion and a fixing slot hole, the fixing protrusion is disposed to protrude from the inner wall of the insulating end cap along the length direction, the fixing slot hole is disposed inside the insulating shell, and the fixing protrusion is inserted into the fixing slot hole; and/or the fixing structure includes a fixing snap protrusion and a fixing snap slot, the fixing snap protrusion is disposed to protrude from a surface of the insulating end cap along a direction perpendicular to the length direction, the fixing snap slot is disposed on the insulating shell, and the fixing snap protrusion is snapped into the fixing snap slot.

16. The wireless adapter of claim 20 wherein a second positioning structure is formed between the insulating shell and the first carrier board, and the second positioning structure is configured to position a relative position between the first carrier board and the insulating shell.

17. The wireless adapter of claim 20, wherein the interface assembly comprises:
an interface housing including a guide cavity, the guide cavity being disposed to penetrate the interface housing along the length direction, and one end of the interface housing along the length direction being sleeved on the first end of the insulating shell;
a third carrier board inserted into the guide cavity along the length direction, the third carrier board and the first carrier board being of an integral structure; and
an interface pin formed on a surface of the third carrier board, the interface pin being electrically connected to the antenna assembly.

18. The wireless adapter of claim 17, wherein the insulating shell includes a supporting structure, the supporting structure is inserted into the guide cavity along the length direction, and the third carrier board is fixedly connected to the supporting structure.

19. The wireless adapter of claim 17, wherein
the antenna assembly further comprises a wireless module, and the interface pin and the first antenna are electrically connected to the wireless module; and
the wireless module is disposed at a position of the first carrier board close to the third carrier board along the length direction, or the wireless module is disposed at a position of the third carrier board close to the first carrier board along the length direction.

20. The wireless adapter of claim 1, further comprising a first carrier board that is disposed in the accommodation cavity and fixedly connected to the housing assembly, the first antenna being formed on a surface of the first carrier board.
